(19) United States
(12) Patent Application Publication
(10) Pub. No.: US 2017/0344403 A1
(43) Pub. Date: Nov. 30, 2017

(54) SPINLOCK METHOD AND APPARATUS

(71) Applicant: Wind River Systems, Inc., Alameda, CA (US)

(72) Inventors: Gregory Stults, Berkley, CA (US); Johan Fornaeus, Alameda, CA (US)

(21) Appl. No.: 15/166,840

(22) Filed: May 27, 2016

(51) Int. Cl. G06F 9/52; G06F 9/50

(52) U.S. Cl. CPC G06F 9/524; G06F 9/5038

(57) ABSTRACT

Apparatuses, methods and storage medium associated with spinlock are disclosed herein. In embodiments, an apparatus for computing may comprise a first and a second processor core to correspondingly execute a first and a second thread; a storage location to store a spinlock to facilitate exclusive access by the first or the second thread to a plurality of resources implicitly shared by the first and second threads; and spin logic to be executed by the second processor core to occupy the second processor core to suspend execution of the second thread to prevent the second thread from using any one of the implicitly shared resources, whenever the spinlock is set by the first thread for exclusive access to one or more of the implicitly shared resources. Other embodiments may be disclosed or claimed.

### TECHNICAL FIELD

The present disclosure relates to the fields of computing. More specifically, the present disclosure is related to spinlock method and apparatus.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

In computing, a lock is often employed to synchronize or enforce limits on access to a resource shared by multiple execution thread. Most lock designs, in particular, spinlock, block the execution thread who wants to acquire the lock and access the shared resource. That is, the execution thread with the need to acquire the lock and access the shared resource would spin, until the lock is available for the execution thread to acquire. Typically, hardware support, such as, an atomic instruction in the form of “test-and-set” is required. Such instruction allows an execution thread that desires locked access to test whether the lock is free, and if free, acquire the lock in a single atomic operation. Further, to avoid contention, i.e., attempt to acquire a lock held by another thread, it is often desirable to implement the locks at fine granular level. For example, in a database management system situation, a separate lock would be used to protect each record or each data page, as opposed to each table, to reduce the likelihood of contention. In general, the more coarse the lock, the higher the likelihood of contention, with a lock acquiring execution thread having to spin.

In most multi-core computing environments, resources such as system memory, system buses, memory controllers, and so forth, are implicitly shared among the firmware or software execution threads respectively executing on the various processor cores. For various applications, it is desirable to be able to efficiently restrict accesses to these shared resources temporarily/momentarily, in particular, if the temporal/momentary restriction can be achieved with reduced or virtually no overhead or serialization. For example, jitters in some real time applications may be desirably decreased, if an execution thread of a real time application reaching a critical section can temporarily/momentarily restrict other threads from accessing the implicitly shared resources in a coarse manner (i.e., without having to employ separate locks for the system memory, the system buses, memory controller, and so forth), and ensuring these implicitly shared resources will be available to the critical section of the execution thread, when needed, during the temporary/momentary restricted/locked period.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a schematic view of the spinlock technology of the present disclosure, in accordance with various embodiments.

FIG. 2 illustrate an example process for providing spinlock service, in accordance with various embodiments.

FIG. 3 illustrates an example operation flow of an execution thread, in accordance with various embodiments.

FIG. 4 illustrates an example operation flow of the spin logic, in accordance with various embodiments.

FIG. 5 illustrates an example computing environment incorporated with the spinlock technology of the present disclosure, in accordance to various embodiments.

### DETAILED DESCRIPTION

Apparatuses, methods and storage medium associated with spinlock are disclosed herein. In embodiments, an apparatus for computing may comprise a processor having at least a first and a second processor core to correspondingly execute a first and a second firmware or software thread; a storage location to store a spinlock to facilitate exclusive access by the first or the second thread to a plurality of resources implicitly shared by the first and second threads; and spin logic to be executed by the second processor core to occupy the second processor core to suspend execution of the second thread to prevent the second thread from using any one of the implicitly shared resources, whenever the spinlock is set by the first thread for exclusive access to one or more of the implicitly shared resources. The second thread does not have a need for exclusive access to one or more of the implicitly shared resources.

In the description to follow, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Operations of various methods may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiments. Various additional operations may be performed and/or described operations may be omitted, split or combined in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used hereinafter, including the claims, the term “module” or “routine” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

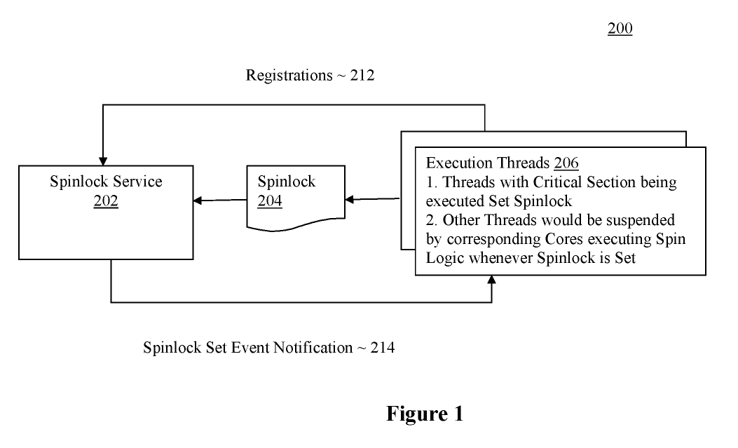

Referring now to FIG. 1, wherein a schematic view of the spinlock technology of the present disclosure, in accordance with various embodiments, is shown. As illustrated, in embodiments, computing environment 200 may include spinlock service 202, spinlock 204 and a plurality of execution threads 206. Execution threads 206 may be executing on a corresponding plurality of processor cores (not shown in FIG. 1, and hereinafter, may also be simply referred to as “cores”). Implicitly, execution threads 206 share various hardware resources of computing environment, such as system memory, system bus, memory controller, and so forth. Additionally, one or more execution threads 206 may have critical sections, during which executions, exclusive access to the implicitly shared resources may be desired.

To enable such exclusive accesses, without excessive overhead or serialization, spinlock 204 may be employed. Spinlock 204 may be stored at a storage location of computing environment 200 that is globally visible and accessible to spinlock service 202 and/or execution threads 206. For example, spinlock 204 may be stored in system memory or a control register of a processor (not shown in FIG. 1) of computing environment 200.

In embodiments, one of execution threads 206 having a need to have temporal/momentary exclusive access to the implicitly shared resources, may set spinlock 204. For example, an execution thread 206 of a real time application may set spinlock 204 just prior to commencement of execution of a critical section of the execution thread. In embodiments, it is not necessary for the execution thread 206 desiring such exclusive access to first check a state of spinlock, e.g., to see if spinlock 204 has been set by another execution thread 206. Accordingly, for the present disclosure, it is not necessary to have hardware support, such as atomic “test-and-set” instruction.

The reason is because, other threads 206, independent of whether these threads have a need or desire to have exclusive access to the implicitly shared resources, would be suspended and prevented from using the implicitly shared resources, as their corresponding cores would be caused to execute a spin logic to occupy the corresponding cores, and preempt execution of the other threads 206. In embodiments, the spin logic may have the highest execution priority to ensure its execution will preempt execution of the other threads 206. In embodiments, the spin logic may be caused to be executed in the other cores by the corresponding other execution threads. In alternate embodiments, other approaches to cause the spin logic to be executed to occupy the corresponding cores, and effectively suspend execution of the other threads 206, and prevent the other threads 206 from using the implicitly shared resources, may be practiced instead (to be further described later). [Note that, under the present disclosure, it is the respective cores that are spinning, and not other threads also with a need to acquire spinlock 204 that are spinning. Under the present disclosure, by virtue of the spinning of all other cores, there will not be contention having another thread with a need to acquire spinlock 204, while the spinlock 204 is set by one of threads 206. However, in embodiments, this strict arrangement may be relaxed (to be further described later).]

In embodiments, to enable other threads 206 to cause their respective cores to spin and effectively suspend execution of the other threads 206, spinlock service 202 may be employed to monitor spinlock 204, and broadcast spinlock set event notifications 214 to other threads 206, whenever spinlock 204 is set by one of threads 206. In embodiments, spinlock service 202 may be configured to accept registration 212 from execution threads 206 as interested recipients of such spinlock set event notifications.

In embodiments, spinlock service 202 may also be configured to initialize spinlock 204 on start up. In embodiments, spinlock service 202 may also be configured to provide execution threads 206 with the location of spinlock 204. In alternate embodiments, other approaches may be employed (to be further described below).

Accordingly, any one of execution threads 206 may be assured exclusive use of the implicitly shared resources of computing environment 200, with relatively low overhead, and without the need of serialization.

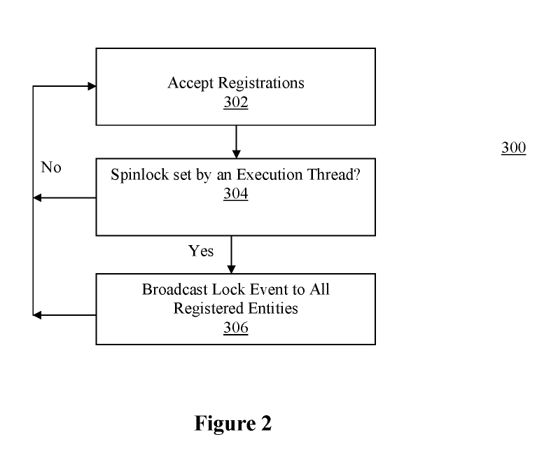

FIG. 2 illustrate an example process for providing spinlock service, in accordance with various embodiments. As shown, example process 300 for providing spinlock service may include operations performed at blocks 302-306. The operations may be performed e.g., by spinlock service 202 of FIG. 1. In other words, process 300 also depicts the algorithmic structure of spinlock service 202.

At block 302, registration of an interest recipient, e.g., an execution thread, for spinlock set event notification may be accepted. The registration may be made in any one of a number of known manners.

At block 304, a determination may be made on whether the spinlock has been set. If a result of the determination is affirmative, at block 306, spinlock set event notification(s) may be broadcast or sent to all registered interest recipients. On broadcast/transmission of the spinlock set event notification(s), process 300 may return to block 302, and continue therefrom as earlier described. Similarly, if a result of the determination at block 304 is negative, process 300 may likewise return to block 302, and continue therefrom as earlier described.

Process 300 may iterate over blocks 302-304 continuously during operation.

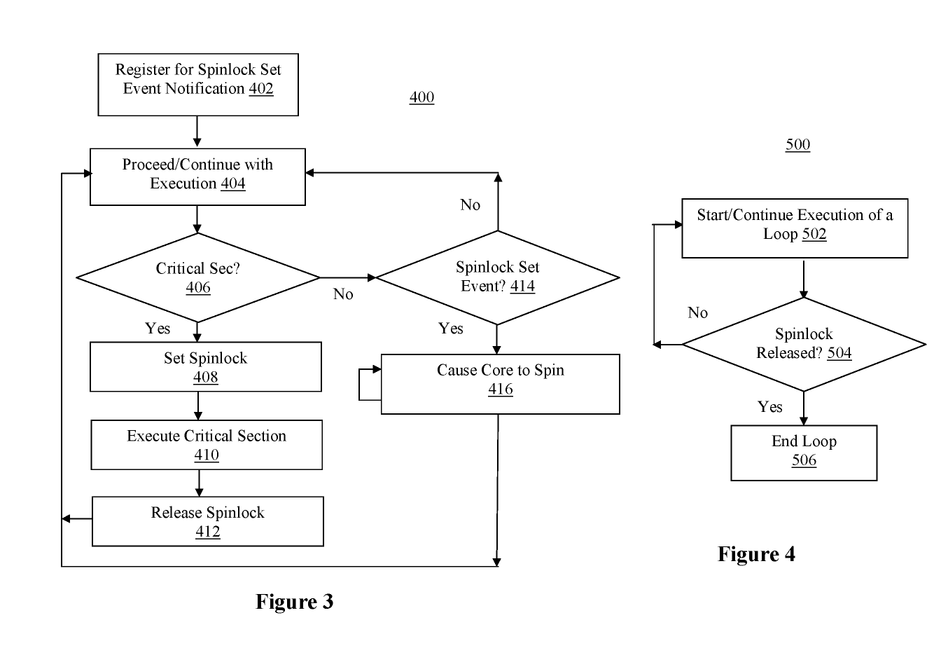

FIG. 3 illustrates an example operation flow of an execution thread, in accordance with various embodiments. As shown, example operation flow 400 of an execution thread may include operations performed at blocks 402-416. The operations may be performed e.g., by any one of threads 206 of FIG. 1. In other words, operation flow 400 also depicts the algorithmic structure of an execution thread 206.

At block 402, a registration may be made, e.g., with spinlock service 202, to receive lock event notification. At block 404, an execution thread may proceed or continue with its execution. At block 406, a determination may be made on whether a critical section of the execution thread has been reached.

If a result of the determination is affirmative, at block 408, the spinlock may be set. As described earlier, the spinlock may be set without having to first check a state of the spinlock to determine if it has been set by other threads. Next, at block 410, the critical section may be executed. Then, at block 412, on completion of execution of the critical section, the spinlock may be released. From block 412, on release of the spinlock, process 400 may return to block 404, and continue therefrom as earlier described.

Back at block 406, if a result of the determination is negative, at block 414, a determination may be made on whether a spinlock set event notification has been received. If a result of the determination is affirmative, at block 416, the corresponding core may be caused to spin, e.g., by executing a spin logic with execution priority higher than the thread. As described earlier, the corresponding core may be caused to spin independent of whether the execution thread also desires to have exclusive access to the implicitly shared resources. That is, the corresponding core may be caused to spin even when the execution thread does not have a desire to have exclusive access to the implicitly shared resources. On causing the corresponding core to spin, process 400 would remain at block 416, until the corresponding core ceases spinning. At such time, process 400 may return to block 404, and continue therefrom as earlier described.

Back at block 414, if a result of the determination is negative, process 400 may return to block 404, and continue therefrom as earlier described.

FIG. 4 illustrates an example operation flow of the spin logic, in accordance with various embodiments. As shown, example operation flow/process 500 of the spin logic may include operations performed at blocks 502-506. The operations may be performed e.g., by the spin logic of FIG. 1. In other words, operation flow 500 also depicts the algorithmic structure of the triggered spin logic.

At block 502, the execution of a loop may be started or continued. At block 504, a determination may be made on whether the spinlock has been released. If a result of the determination is affirmative, at block 506, the loop may be exited, and process 500 may terminate. If a result of the determination is negative, process 500 may return to block 502, and continue therefrom as earlier described.

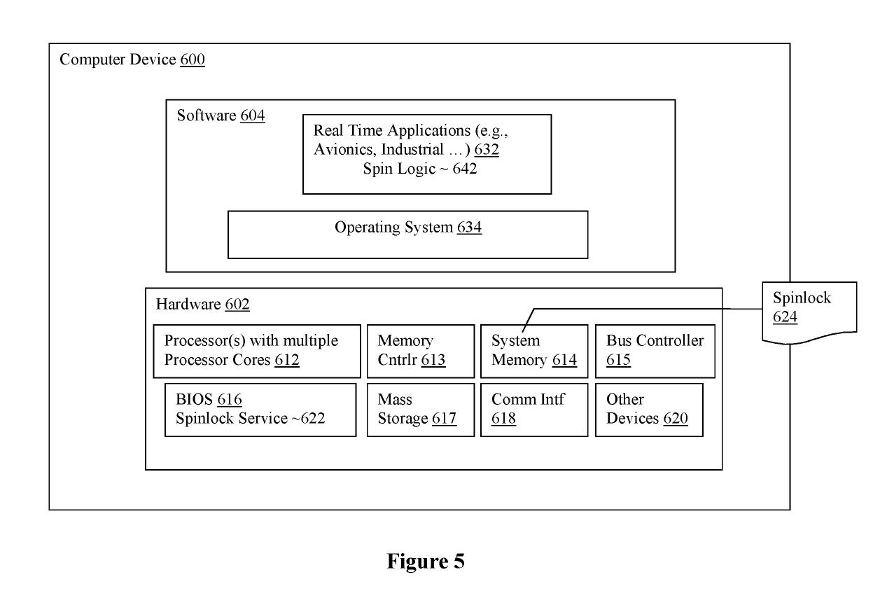

FIG. 5 illustrates an example computing environment incorporated with the spinlock technology of the present disclosure, in accordance to various embodiments. As illustrated, in embodiments, computer device 600 may include hardware 602 and software 604. Software 604 may include real time applications 632 and operating system (OS) 634. Examples of real time applications may include, but are not limited to, avionics and industrial applications. In embodiments, applications 632 may include spin logic 642, which may be configured to practice spin process 500 of FIG. 5 (i.e., having the algorithmic structure as depicted by FIG. 5). OS 334 may be any one of a number of OS known in art.

Hardware 602 may include processor(s) 612, memory controller 613, system memory 614, bus controller 615, basic input/output system (BIOS) 616, mass storage 617, communication interface 618 and other devices 620. Processor(s) 612 may be any one of a number of processors known in the art, each having one or more processor cores. And each processor core may include one or more levels of private caches. Processor(s) 612 may be configured to execute BIOS 616 and software 604, including applications 632 (with spin logic 642), and OS 634. In embodiments, various execution threads of applications 632 may correspondingly execute in the various processor cores of processor(s) 612.

Memory controller 613 and system memory 614 may be any known memory controller, and volatile or non-volatile memory in the art, suitable for storing instructions for execution and working data, in particular, instructions and data of applications 632 and OS 634, including spin logic 642. System memory 614 may be organized into memory pages. In embodiments, system memory 614 may be used to store spinlock 624, which may be spinlock 204 of FIG. 1. As described earlier, in alternate embodiments, spinlock 624 may be stored in a control register of processor 612 instead. Bus controller 615 may be any one of a number of known bus controllers. As shown, BIOS 616 may include spin lock service 622, which may be spinlock service 202 of FIG. 1. In alternate embodiments, spinlock service 622 may be part of OS 634 instead. BIOS 616, except for spin lock service 622, may be any one of a number of firmware BIOS known in the art.

Mass storage 616 may be any known persistent mass storage suitable for providing persistent storage of instructions and data of applications 632 and OS 634, e.g., solid state storage, magnetic or optical disk drives. Communication interface 618 may include any number of wireless communication or networking interfaces known, such as WiFi, 3G/4G, Bluetooth®, Near Field Communication, and so forth. Communication interface 322 may also include wired/wireless display interface, including but are not limited to DisplayPort (DP), Digital Visual Interface (DVI), High-Definition Multimedia Interface (HDMI), and so forth. Other devices 620 may include any one of a number of computer peripherals, including but are not limited to (touch sensitive) displays, keyboards, cursor controls, global positions systems (GPS), sensors, cameras, gyroscopes, and so forth.

In embodiments, computer device 600 may be any one of a wearable device, a smartphone, a computer tablet, a notebook computer, a laptop computer, an ebook, a game console, a set-top box, a desktop computer, or a server.

In alternate embodiments, OS 634 may include a loader (not shown) to load execution threads of applications 632 into system memory 614 for execution. For some of these embodiments, the loader may be configured to provide (resolve) the location of spinlock 624 for the execution threads.

In alternate embodiments, OS 634 may include a scheduler (not shown) to schedule execution of execution threads of applications 632. For some of these embodiments, spin logic 642 may be part of OS 634 or BIOS 616, and when setting spinlock 624, an execution thread may also include its identifier with the setting. For these embodiments, the scheduler may be configured to either monitor spinlock 624 directly or register with spinlock service 622 to receive spinlock set event notifications. On observing or receiving notifications that spinlock 624 is set, the scheduler may cause spin logic 642 to be executed in the cores executing the other threads, to spin these cores, and suspend execution of the other threads, to prevent these other threads from using the implicitly shared resources, thereby effectively providing the execution threads who set the spinlock with exclusive access to the implicitly shared resources.

While for ease of understanding, the present disclosure has been described thus far, with all corresponding cores of all other threads caused to spin, whenever one execution thread sets the spinlock, however the present disclosure is not so limiting. In some embodiments, e.g., where execution threads may have semi-critical sections, as opposed to critical sections, and merely desire reduced likelihood of contending for the implicit shared resources, the low overhead without serialization spinlock of the present disclosure may be relaxed to allow setting of the spinlock by multiple execution threads.

For example, the spinlock may be a counter with an initial value, e.g., 0, (initialized e.g., by the spinlock service), and an execution thread prior to commencement of execution of a semi-critical section may set the spinlock by incrementing the spinlock counter by a predetermined amount, e.g., 1. Similar to the earlier described embodiments, an execution thread may set/increment the spinlock counter without first checking the state of the spinlock counter to determine whether it has been set/incremented by other threads. The spinlock service monitoring the spinlock counter, would broadcast spinlock set event notifications whenever the spinlock counter becomes greater than the initial value, e.g., non-zero. In response, cores executing execution threads with no semi-critical sections or execution threads not likely to execute semi-critical sections for a predetermined amount of time may be caused to spin (i.e., by executing the spin logic). However, cores executing execution threads with semi-critical sections or execution threads likely to execute semi-critical sections within a predetermined amount of time will continue to execute the respective execution threads, and not caused to spin. Thus, prior to commencement of executing their semi-critical sections, these other execution threads may also set the spinlock counter by incrementing the spinlock counter by a predetermined amount. Each of the executing threads having increment the spinlock counter would decrement the spinlock counter by the same amount, when execution of the semi-critical section is completed. The spin logic would exit and cease to spin a core whenever the spinlock is decrement back to its initial value (e.g., zero). Accordingly, for these embodiments, the low overhead, without serialization spinlock of the present disclosure may be employed to increase likelihood of availability of the implicitly shared resources, as opposed to ensuring exclusive access to the implicitly shared resources.

Thus, example embodiments described may include:

Example 1 may be an apparatus for computing, comprising: a processor having at least a first and a second processor core to correspondingly execute a first and a second firmware or software thread; a storage location to store a spinlock to facilitate exclusive access by the first or the second thread to a plurality of resources implicitly shared by the first and second threads; and spin logic to be executed by the second processor core to occupy the second processor core to suspend execution of the second thread to prevent the second thread from using any one of the implicitly shared resources, whenever the spinlock is set by the first thread for exclusive access to one or more of the implicitly shared resources; wherein the second thread does not have a need for exclusive access to one or more of the implicitly shared resources.

Example 2 may be example 1, wherein the spin logic may have higher execution priority than the second thread.

Example 3 may be example 1, wherein the first thread may set the spinlock, without having to check a state of the spinlock, prior to commencing execution of a critical section of the first thread to ensure the implicitly shared resources are available to the first thread, if needed, during execution of the critical section of the first thread.

Example 4 may be example 3, wherein the first thread may release the spinlock on completion of execution of the critical section of the first thread.

Example 5 may be example 4, wherein the spin logic may cease occupation of the second processor core to resume execution of the second thread on release of the spinlock by the first thread.

Example 6 may be example 3, may further comprise a spinlock service to initialize the spinlock at the storage location; wherein the storage location is accessible to the first thread and visible to the spin logic.

Example 7 may be example 6, wherein the first thread may obtain the storage location from the spinlock service, or the apparatus may further comprise a loader to load the first thread for execution, and provide the first thread with the storage location.

Example 8 may be example 6, wherein the second thread may register with the spinlock service to receive a spinlock set event notification from the spinlock service whenever the spinlock is set; and wherein the spinlock service may accept registration of the second thread, monitor the spinlock, and on detection that the spinlock is set, provide the second thread with the spinlock set event notification.

Example 9 may be example 6, wherein the apparatus may further comprise a basic input/output system (BIOS) having the spinlock service or the spin logic.

Example 10 may be any one of examples 1-9, wherein the processor may comprise a control register, and wherein the storage location is disposed within the control register.

Example 11 may be any one of examples 1-9, wherein the apparatus may further comprise a system memory having the storage location.

Example 12 may be any one of examples 1-9, wherein the second thread may comprise the spin logic.

Example 13 may be any one of examples 1-9, wherein the plurality of resources of the apparatus implicitly shared by the first and second threads comprise a system memory, a memory controller, or a system bus of the apparatus.

Example 14 may be any one of examples 1-9, wherein the spin logic may be a first spin logic, the processor core may further comprise a third processor core to execute a third firmware or software thread; and the spinlock may facilitate exclusive access by the first, the second or the third thread to the plurality of resources implicitly shared by the first and second threads, as well as the third thread; and wherein the apparatus may further comprise:

second spin logic to be executed by the third processor core to occupy the third processor core to effectively suspend execution of the third thread to prevent the third thread from using any one of the implicitly shared resources, wherein the third thread does not have a need for exclusive access to one or more of the implicitly shared resources.

Example 15 may be any one of examples 1-9, wherein the processor core may further comprise a third processor core to execute a third firmware or software thread; and the spinlock may facilitate exclusive access by a subset of the first, the second and the third thread to the plurality of resources implicitly shared by the first and second threads, as well as the third thread; and wherein the spin logic may be executed by the second processor core to occupy the second processor core to effectively suspend execution of the second thread to prevent the second thread from using any one of the implicitly shared resources, whenever the spinlock may be set by either the first thread, the third thread or both the first and third thread for exclusive access to one or more of the implicitly shared resources.

Example 16 may be example 15, wherein the first or third thread may set the spinlock, without having to first check a state of the spinlock, prior to commencing execution of a semi-critical section of the first or third thread to increase likelihood of the implicitly shared resources are available to the first or third thread, if needed, during execution of the semi-critical section of the first or third thread.

Example 17 may be example 16, wherein the spinlock may be a counter with an initial value, and the first or third thread sets the spinlock by incrementing the counter; and wherein the first or third thread may release the spinlock on completion of execution of the semi-critical section of the first or third thread by decrementing the counter.

Example 18 may be example 17, wherein the spin logic may cease occupation of the second processor core to resume execution of the second thread on release of the spinlock by the first and third threads, when the spinlock counter is decremented to the initial value.

Example 19 may be a method for computing on an apparatus with a first processor core executing a first firmware or software thread, the method comprising: executing, by a second processor core of the apparatus, a second firmware or software thread; wherein the apparatus includes a plurality of resources implicitly shared by the first and second threads; and executing , by the second processor core, a spin logic to occupy the second processor core to suspend execution of the second thread to prevent the second thread from using any one of the implicitly shared resources, whenever a spinlock disposed at a storage location of the apparatus is set by the first thread for exclusive access to the implicitly shared resources; wherein the second thread does not have a need for exclusive access to one or more of the implicitly shared resources.

Example 20 may be example 19, wherein the spin logic may have higher execution priority than the second thread.

Example 21 may be example 19, wherein the method may further comprise setting, by the first thread, the spinlock, without checking a state of the spinlock, prior to commencing execution of a critical section of the first thread to ensure the implicitly shared resources are available to the first thread, if needed, during execution of the critical section of the first thread.

Example 22 may be example 21, wherein the method may further comprise releasing, by the first thread, the spinlock on completion of execution of the critical section of the first thread.

Example 23 may be example 22, wherein the method may further comprise ceasing, by the spin logic, occupation of the second processor core to resume execution of the second thread on release of the spinlock by the first thread.

Example 24 may be example 21, wherein the method may further comprise initializing, by a spinlock service, the spinlock at the storage location; wherein the storage location may be accessible to the first thread and visible to the spin logic.

Example 25 may be example 24, wherein the method may further comprise obtaining, by the first thread, the storage location from the spinlock service, or loading, by a loader of the apparatus, the first thread for execution, and providing the first thread with the storage location.

Example 26 may be example 24, wherein the method may further comprise registering, by the second thread, with the spinlock service to receive a spinlock set event notification from the spinlock service whenever the spinlock is set; and accepting, by the spinlock service, registration of the second thread, monitoring the spinlock, and on detection that the spinlock is set, providing the second thread with the spinlock set event notification.

Example 27 may be example 24, wherein either the spinlock service or the spin logic is part of a basic input/output system (BIOS) of the apparatus.

Example 28 may be any one of examples 19-27, wherein the apparatus may comprise a processor having a control register, and the storage location is disposed within the control register.

Example 29 may be any one of examples 19-27, wherein the apparatus may comprise a system memory having the storage location.

Example 30 may be any one of examples 19-27, wherein the second thread may comprise the spin logic.

Example 31 may be any one of examples 19-27, wherein the plurality of resources of the apparatus implicitly shared by the first and second threads comprise a system memory, a memory controller, or a system bus of the apparatus.

Example 32 may be any one of examples 19-27, wherein the spin logic may be a first spin logic, the apparatus may further comprise a third processor core to execute a third firmware or software thread; and the spinlock may facilitate exclusive access by the first, the second or the third thread to the plurality of resources implicitly shared by the first and second threads, as well as the third thread; and wherein the method may further comprise:

executing, by the third processor core, second spin logic to occupy the third processor core to effectively suspend execution of the third thread to prevent the third thread from using any one of the implicitly shared resources, wherein the third thread does not have a need for exclusive access to one or more of the implicitly shared resources.

Example 33 may be any one of examples 19-27, wherein the apparatus may further comprise a third processor core to execute a third firmware or software thread; and the spinlock may facilitate exclusive access by a subset of the first, the second and the third thread to the plurality of resources implicitly shared by the first and second threads, as well as the third thread; and wherein the method may further comprise executing, by the second processor core, the spin logic to occupy the second processor core to effectively suspend execution of the second thread to prevent the second thread from using any one of the implicitly shared resources, whenever the spinlock is set by either the first thread, the third thread or both the first and third thread for exclusive access to one or more of the implicitly shared resources.

Example 34 may be example 33, may further comprise setting, by the first or third thread, the spinlock, without first checking a state of the spinlock, prior to commencing execution of a semi-critical section of the first or third thread to increase likelihood of the implicitly shared resources are available to the first or third thread, if needed, during execution of the semi-critical section of the first or third thread.

Example 35 may be example 34, wherein the spinlock may be a counter with an initial value, and the first or third thread setting the spinlock by incrementing the counter; and wherein the method may further comprise releasing, by the first or third thread, the spinlock on completion of execution of the semi-critical section of the first or third thread by decrementing the counter.

Example 36 may be example 35, wherein the method may further comprise ceasing, by the spin logic, occupation of the second processor core to resume execution of the second thread on release of the spinlock by the first and third threads, when the spinlock counter is decremented to the initial value.

Example 37 may be one or more computer-readable media comprising instructions that cause a computer device having a first processor core executing a first firmware or software thread, in response to execution of the instructions by a second processor core the computer device, to cause the computer device to: execute on the second processor core a second firmware or software thread, wherein the apparatus includes a plurality of resources implicitly shared by the first and second threads; and execute spin logic on the second processor core to occupy the second processor core to suspend execution of the second thread to prevent the second thread from using any one of one or more resources of the apparatus implicitly shared by the first and second threads, whenever a spinlock is set by the first thread for exclusive access to the implicitly shared resources; wherein the second thread does not have a need for exclusive access to one or more of the implicitly shared resources.

Example 38 may be example 37, wherein the spin logic may have higher execution priority than the second thread.

Example 39 may be example 37, wherein the first thread may set the spinlock, without having to check a state of the spinlock, prior to commencing execution of a critical section of the first thread to ensure the implicitly shared resources are available to the first thread, if needed, during execution of the critical section of the first thread.

Example 40 may be example 39, wherein the first thread may release the spinlock on completion of execution of the critical section of the first thread.

Example 41 may be example 40, wherein the spin logic may cease occupation of the second processor core to resume execution of the second thread on release of the spinlock by the first thread.

Example 42 may be example 39, may further comprise a spinlock service to initialize the spinlock at the storage location; wherein the storage location is accessible to the first thread and visible to the spin logic.

Example 43 may be example 42, wherein the first thread may obtain the storage location from the spinlock service, or the computing device may further comprise a loader to load the first thread for execution, and provide the first thread with the storage location.

Example 44 may be example 42, wherein the second thread may register with the spinlock service to receive a spinlock set event notification from the spinlock service whenever the spinlock is set; and wherein the spinlock service may accept registration of the second thread, monitor the spinlock, and on detection that the spinlock is set, provide the second thread with the spinlock set event notification.

Example 45 may be example 42, wherein the computing device may further comprise a basic input/output system (BIOS) having the spinlock service or the spin logic.

Example 46 may be any one of example 37-45, wherein the computing device may comprise a processor having the first and second processor cores, and a control register, and wherein the storage location is disposed within the control register.

Example 47 may be any one of example 37-45, wherein the computing device may further comprise a system memory having the storage location.

Example 48 may be any one of example 37-45, wherein the second thread may comprise the spin logic.

Example 49 may be any one of example 37-45, wherein the plurality of resources of the computing device implicitly shared by the first and second threads comprise a system memory, a memory controller, or a system bus of the apparatus.

Example 50 may be any one of example 37-45, wherein the spin logic may be a first spin logic, the processor core may further comprise a third processor core to execute a third firmware or software thread; and the spinlock may facilitate exclusive access by the first, the second or the third thread to the plurality of resources implicitly shared by the first and second threads, as well as the third thread; and wherein the computing device may further comprise: second spin logic to be executed by the third processor core to occupy the third processor core to effectively suspend execution of the third thread to prevent the third thread from using any one of the implicitly shared resources, wherein the third thread does not have a need for exclusive access to one or more of the implicitly shared resources.

Example 51 may be any one of example 37-45, wherein the processor core may further comprise a third processor core to execute a third firmware or software thread; and the spinlock may facilitate exclusive access by a subset of the first, the second and the third thread to the plurality of resources implicitly shared by the first and second threads, as well as the third thread; and wherein the spin logic may be executed by the second processor core to occupy the second processor core to effectively suspend execution of the second thread to prevent the second thread from using any one of the implicitly shared resources, whenever the spinlock is set by either the first thread, the third thread or both the first and third thread for exclusive access to one or more of the implicitly shared resources.

Example 52 may be example 51, wherein the first or third thread may set the spinlock, without having to first check a state of the spinlock, prior to commencing execution of a semi-critical section of the first or third thread to increase likelihood of the implicitly shared resources are available to the first or third thread, if needed, during execution of the semi-critical section of the first or third thread.

Example 53 may be example 52, wherein the spinlock is a counter with an initial value, and the first or third thread sets the spinlock by incrementing the counter; and wherein the first or third thread may release the spinlock on completion of execution of the semi-critical section of the first or third thread by decrementing the counter.

Example 54 may be example 53, wherein the spin logic may cease occupation of the second processor core to resume execution of the second thread on release of the spinlock by the first and third threads, when the spinlock counter is decremented to the initial value.

Example 55 may be an apparatus for computing on an apparatus with a first processor core executing a first firmware or software thread, comprising: first and second execution means for correspondingly executing a first and a second firmware or software thread; and storage means for storing a spinlock to facilitate exclusive access by the first or the second thread to a plurality of resources implicitly shared by the first and second threads; wherein the second execution means are also for executing spin logic to occupy the second execution means to suspend execution of the second thread to prevent the second thread from using any one of the implicitly shared resources, whenever the spinlock is set by the first thread for exclusive access to the implicitly shared resources; wherein the second thread does not have a need for exclusive access to one or more of the implicitly shared resources.

Example 56 may be example 55, wherein the spin logic may have higher execution priority than the second thread.

Example 57 may be example 55, wherein the first thread may set the spinlock, without checking a state of the spinlock, prior to commencing execution of a critical section of the first thread to ensure the implicitly shared resources are available to the first thread, if needed, during execution of the critical section of the first thread.

Example 58 may be example 57, wherein the first thread may release the spinlock on completion of execution of the critical section of the first thread.

Example 59 may be example 58, wherein the spin logic may cease occupation of the second processor core to resume execution of the second thread on release of the spinlock by the first thread.

Example 60 may be example 57, wherein the apparatus may further comprise a spinlock service to initialize the spinlock at the storage location; wherein the storage location is accessible to the first thread and visible to the spin logic.

Example 61 may be example 60, wherein the first thread may obtain the storage location from the spinlock service, or the apparatus may further comprise a loader to load the first thread for execution, and provide the first thread with the storage location.

Example 62 may be example 60, wherein the second thread may register with the spinlock service to receive a spinlock set event notification from the spinlock service whenever the spinlock is set; and wherein the spinlock service may accept the registration of the second thread, monitor the spinlock, and on detection that the spinlock is set, provide the second thread with the spinlock set event notification.

Example 63 may be example 60, may further comprise a basic input/output system (BIOS) having either the spinlock service or the spin logic.

Example 64 may be any one of examples 55-63, wherein the apparatus may comprise a processor having the first and second execution means, and a control register, and the storage location is disposed within the control register.

Example 65 may be any one of examples 55-63, wherein the apparatus may comprise a system memory having the storage location.

Example 66 may be any one of examples 55-63, wherein the second thread may comprise the spin logic.

Example 67 may be any one of examples 55-63, wherein the plurality of resources of the apparatus implicitly shared by the first and second threads comprise a system memory, a memory controller, or a system bus of the apparatus.

Example 68 may be any one of examples 55-63, wherein the spin logic may be a first spin logic, the apparatus may further comprise third execution means for executing a third firmware or software thread; and the spinlock may facilitate exclusive access by the first, the second or the third thread to the plurality of resources implicitly shared by the first and second threads, as well as the third thread; and wherein the third execution means is also for executing second spin logic to occupy the third execution means to effectively suspend execution of the third thread to prevent the third thread from using any one of the implicitly shared resources, wherein the third thread does not have a need for exclusive access to one or more of the implicitly shared resources.

Example 69 may be any one of examples 55-63, wherein the apparatus may further comprise third execution means for executing a third firmware or software thread; and the spinlock may facilitate exclusive access by a subset of the first, the second and the third thread to the plurality of resources implicitly shared by the first and second threads, as well as the third thread; and wherein the second execution means is also for executing the spin logic to occupy the second processor core to effectively suspend execution of the second thread to prevent the second thread from using any one of the implicitly shared resources, whenever the spinlock is set by either the first thread, the third thread or both the first and third thread for exclusive access to one or more of the implicitly shared resources.

Example 70 may be example 69, wherein the first or third thread may set the spinlock, without first checking a state of the spinlock, prior to commencing execution of a semi-critical section of the first or third thread to increase likelihood of the implicitly shared resources are available to the first or third thread, if needed, during execution of the semi-critical section of the first or third thread.

Example 71 may be example 70, wherein the spinlock is a counter with an initial value, and the first or third thread may set the spinlock by incrementing the counter; and wherein the first or third thread may release the spinlock on completion of execution of the semi-critical section of the first or third thread by decrementing the counter.

Example 72 may be example 71, wherein the spin logic may cease occupation of the second processor core to resume execution of the second thread on release of the spinlock by the first and third threads, when the spinlock counter is decremented to the initial value.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. An apparatus for computing, comprising:
a processor having at least a first and a second processor core to correspondingly execute a first and a second firmware or software thread;
a storage location to store a spinlock to facilitate exclusive access by the first or the second thread to a plurality of resources implicitly shared by the first and second threads; and
spin logic to be executed by the second processor core to occupy the second processor core to suspend execution of the second thread to prevent the second thread from using any one of the implicitly shared resources, whenever the spinlock is set by the first thread for exclusive access to one or more of the implicitly shared resources;
wherein the second thread does not have a need for exclusive access to one or more of the implicitly shared resources.

2. The apparatus of claim 1, wherein the spin logic has higher execution priority than the second thread.

3. The apparatus of claim 1, wherein the first thread is to set the spinlock, without having to check a state of the spinlock, prior to commencing execution of a critical section of the first thread to ensure the implicitly shared resources are available to the first thread, if needed, during execution of the critical section of the first thread.

4. The apparatus of claim 3, wherein the first thread is to release the spinlock on completion of execution of the critical section of the first thread.

5. The apparatus of claim 4, wherein the spin logic is to cease occupation of the second processor core to resume execution of the second thread on release of the spinlock by the first thread.

6. The apparatus of claim 3, further comprising a spinlock service to initialize the spinlock at the storage location; wherein the storage location is accessible to the first thread and visible to the spin logic.

7. The apparatus of claim 6, wherein the first thread is to obtain the storage location from the spinlock service, or the apparatus further comprises a loader to load the first thread for execution, and provide the first thread with the storage location.

8. The apparatus of claim 6, wherein the second thread is to register with the spinlock service to receive a spinlock set event notification from the spinlock service whenever the spinlock is set; and wherein the spinlock service is to accept registration of the second thread, monitor the spinlock, and on detection that the spinlock is set, provide the second thread with the spinlock set event notification.

9. The apparatus of claim 6, further comprising a basic input/output system (BIOS) having the spinlock service or the spin logic.

10. The apparatus of claim 1, wherein the processor comprises a control register, and the storage location is disposed within the control register, or the apparatus further comprises a system memory having the storage location; and
wherein the plurality of resources of the apparatus implicitly shared by the first and second threads comprise a system memory, a memory controller, or a system bus of the apparatus.

11. The apparatus of claim 1, wherein the second thread comprises the spin logic.

12. The apparatus of claim 1, wherein the spin logic is a first spin logic, the processor core further comprises a third processor core to execute a third firmware or software thread; and
the spinlock is to facilitate exclusive access by the first, the second or the third thread to the plurality of resources implicitly shared by the first and second threads, as well as the third thread; and wherein the apparatus further comprises:
second spin logic to be executed by the third processor core to occupy the third processor core to effectively suspend execution of the third thread to prevent the third thread from using any one of the implicitly shared resources, wherein the third thread does not have a need for exclusive access to one or more of the implicitly shared resources.

13. The apparatus of claim 1, wherein the processor core further comprises a third processor core to execute a third firmware or software thread; and the spinlock is to facilitate exclusive access by a subset of the first, the second and the third thread to the plurality of resources implicitly shared by the first and second threads, as well as the third thread; and wherein the spin logic is to be executed by the second processor core to occupy the second processor core to effectively suspend execution of the second thread to prevent the second thread from using any one of the implicitly shared resources, whenever the spinlock is set by either the first thread, the third thread or both the first and third thread for exclusive access to one or more of the implicitly shared resources.

14. The apparatus of claim 13, wherein the first or third thread is to set the spinlock, without having to first check a state of the spinlock, prior to commencing execution of a semi-critical section of the first or third thread to increase likelihood of the implicitly shared resources are available to the first or third thread, if needed, during execution of the semi-critical section of the first or third thread.

15. The apparatus of claim 14, wherein the spinlock is a counter with an initial value, and the first or third thread sets the spinlock by incrementing the counter; and wherein the first or third thread is to release the spinlock on completion of execution of the semi-critical section of the first or third thread by decrementing the counter; and
wherein the spin logic is to cease occupation of the second processor core to resume execution of the second thread on release of the spinlock by the first and third threads, when the spinlock counter is decremented to the initial value.

16. A method for computing on an apparatus with a first processor core executing a first firmware or software thread, the method comprising:
executing, by a second processor core of the apparatus, a second firmware or software thread; wherein the apparatus includes a plurality of resources implicitly shared by the first and second threads; and
executing , by the second processor core, a spin logic to occupy the second processor core to suspend execution of the second thread to prevent the second thread from using any one of the implicitly shared resources, whenever a spinlock disposed at a storage location of the apparatus is set by the first thread for exclusive access to the implicitly shared resources; wherein the second thread does not have a need for exclusive access to one or more of the implicitly shared resources.

17. The method of claim 16, further comprising setting, by the first thread, the spinlock, without checking a state of the spinlock, prior to commencing execution of a critical section of the first thread to ensure the implicitly shared resources are available to the first thread, if needed, during execution of the critical section of the first thread;
releasing, by the first thread, the spinlock on completion of execution of the critical section of the first thread; and
ceasing, by the spin logic, occupation of the second processor core to resume execution of the second thread on release of the spinlock by the first thread.

18. The method of claim 16, wherein the spin logic is a first spin logic, the apparatus further comprises a third processor core to execute a third firmware or software thread; and the spinlock is to facilitate exclusive access by the first, the second or the third thread to the plurality of resources implicitly shared by the first and second threads, as well as the third thread; and wherein the method further comprises:
executing, by the third processor core, second spin logic to occupy the third processor core to effectively suspend execution of the third thread to prevent the third thread from using any one of the implicitly shared resources, wherein the third thread does not have a need for exclusive access to one or more of the implicitly shared resources.

19. The method of claim 16, wherein the apparatus further comprises a third processor core to execute a third firmware or software thread; and the spinlock is to facilitate exclusive access by a subset of the first, the second and the third thread to the plurality of resources implicitly shared by the first and second threads, as well as the third thread; and wherein the method further comprises executing, by the second processor core, the spin logic to occupy the second processor core to effectively suspend execution of the second thread to prevent the second thread from using any one of the implicitly shared resources, whenever the spinlock is set by either the first thread, the third thread or both the first and third thread for exclusive access to one or more of the implicitly shared resources.

20. The method of claim 19, wherein the spinlock is a counter with an initial value, and the first or third thread setting the spinlock by incrementing the counter; and wherein the method further comprises releasing, by the first or third thread, the spinlock on completion of execution of the semi-critical section of the first or third thread by decrementing the counter; and ceasing, by the spin logic, occupation of the second processor core to resume execution of the second thread on release of the spinlock by the first and third threads, when the spinlock counter is decremented to the initial value.

21. One or more computer-readable media comprising instructions that cause a computer device having a first processor core executing a first firmware or software thread, in response to execution of the instructions by a second processor core the computer device, to cause the computer device to:
execute on the second processor core a second firmware or software thread, wherein the apparatus includes a plurality of resources implicitly shared by the first and second threads; and
execute spin logic on the second processor core to occupy the second processor core to suspend execution of the second thread to prevent the second thread from using any one of one or more resources of the apparatus implicitly shared by the first and second threads, whenever a spinlock is set by the first thread for exclusive access to the implicitly shared resources; wherein the second thread does not have a need for exclusive access to one or more of the implicitly shared resources.

22. The one or more computer-readable media of claim 21, wherein the first thread is to set the spinlock, without having to check a state of the spinlock, prior to commencing execution of a critical section of the first thread to ensure the implicitly shared resources are available to the first thread, if needed, during execution of the critical section of the first thread; wherein the first thread is to further release the spinlock on completion of execution of the critical section of the first thread; and wherein the spin logic is to cease occupation of the second processor core to resume execution of the second thread on release of the spinlock by the first thread.

23. The one or more computer-readable media of claim 21, wherein the spin logic is a first spin logic, the processor core further comprises a third processor core to execute a third firmware or software thread; and the spinlock is to facilitate exclusive access by the first, the second or the third thread to the plurality of resources implicitly shared by the first and second threads, as well as the third thread; and wherein the computing device further comprises:
second spin logic to be executed by the third processor core to occupy the third processor core to effectively suspend execution of the third thread to prevent the third thread from using any one of the implicitly shared resources, wherein the third thread does not have a need for exclusive access to one or more of the implicitly shared resources.

24. The one or more computer-readable media of claim 21, wherein the processor core further comprises a third processor core to execute a third firmware or software thread; and the spinlock is to facilitate exclusive access by a subset of the first, the second and the third thread to the plurality of resources implicitly shared by the first and second threads, as well as the third thread; and wherein the spin logic is to be executed by the second processor core to occupy the second processor core to effectively suspend execution of the second thread to prevent the second thread from using any one of the implicitly shared resources, whenever the spinlock is set by either the first thread, the third thread or both the first and third thread for exclusive access to one or more of the implicitly shared resources.

25. The one or more computer-readable media of claim 24, wherein the first or third thread is to set the spinlock, without having to first check a state of the spinlock, prior to commencing execution of a semi-critical section of the first or third thread to increase likelihood of the implicitly shared resources are available to the first or third thread, if needed, during execution of the semi-critical section of the first or third thread; wherein the spinlock is a counter with an initial value, and the first or third thread sets the spinlock by incrementing the counter; and wherein the first or third thread is to release the spinlock on completion of execution of the semi-critical section of the first or third thread by decrementing the counter; and wherein the spin logic is to cease occupation of the second processor core to resume execution of the second thread on release of the spinlock by the first and third threads, when the spinlock counter is decremented to the initial value.
